(19) United States
(12) Patent Application Publication
(10) Pub. No.: US 2020/0372363 A1
(43) Pub. Date: Nov. 26, 2020

(54) Method of Training Artificial Neural Network Using Sparse Connectivity Learning

(71) Applicant: Kneron (Taiwan) Co., Ltd., Taipei City (TW)

(72) Inventors: ZHIMIN TANG, Zhangsha City (CN); Bike Xie, San Diego, CA (US); YIYU ZHU, Nantong City (CN)

(21) Appl. No.: 16/746,941

(22) Filed: Jan. 19, 2020

Related U.S. Application Data
(60) Provisional application No. 62/851,652, filed on May 23, 2019.

(51) Int. Cl. G06N 3/08; G06N 3/063; G06N 5/04; G06N 20/00

(52) U.S. Cl. CPC G06N 3/084; G06N 20/00; G06N 5/046; G06N 3/063

(57) ABSTRACT

A computing network includes a plurality of processing nodes. A method of training the computing network includes a processing node in the plurality of processing nodes computing an output estimate according to a weight defined by a weight variable and a connectivity mask, and adjusting connectivity variables according to an objective function to reduce a total number of connections between the plurality of processing nodes and reduce a performance loss indicative of how different the output estimate is from a target value. The connectivity mask represents a connection between the processing node and a preceding processing node in the plurality of processing nodes and is derived from a connectivity variable.

### CROSS REFERENCE TO RELATED APPLICATIONS

This application claims the benefit of U.S. Provisional Application No. 62/851,652, filed on May 23, 2019, and included herein by reference in its entirety.

### BACKGROUND OF THE INVENTION

### 1. Field of the Invention

The invention relates to artificial neural networks, and in particular, to a method of training an artificial neural network using sparse connectivity learning.

### 2. Description of the Prior Art

An artificial neural network is a network including multiple processing units arranged in layers and operating in parallel. Typically, a conventional artificial neural network is fully connected, that is, all processing units in one layer are connected to all processing units in the preceding layer. However, such network arrangements are often complex in structure, require excessive memory resources and power consumption, and suffer from overfitting.

### SUMMARY OF THE INVENTION

According to one embodiment of the invention, a computing network includes a plurality of processing nodes. A method of training the computing network includes: a processing node in the plurality of processing nodes computing an output estimate according to a weight defined by a weight variable and a connectivity mask, the connectivity mask representing a connection between the processing node and a preceding processing node in the plurality of processing nodes and being derived from a connectivity variable; and adjusting connectivity variables according to an objective function to reduce a total number of connections between the plurality of processing nodes and reduce a performance loss indicative of how different the output estimate is from a target value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a computational graph of an artificial neural network according to an embodiment of the invention.

FIG. 2 is a schematic diagram of a processing node Nₖ^{j} in the artificial neural network in FIG. 1.

FIG. 3 is a flowchart of a training method for use to train the artificial neural network in FIG. 1.

FIG. 4 illustrates an exemplary computing network for constructing the artificial neural network in FIG. 1.

### DETAILED DESCRIPTION

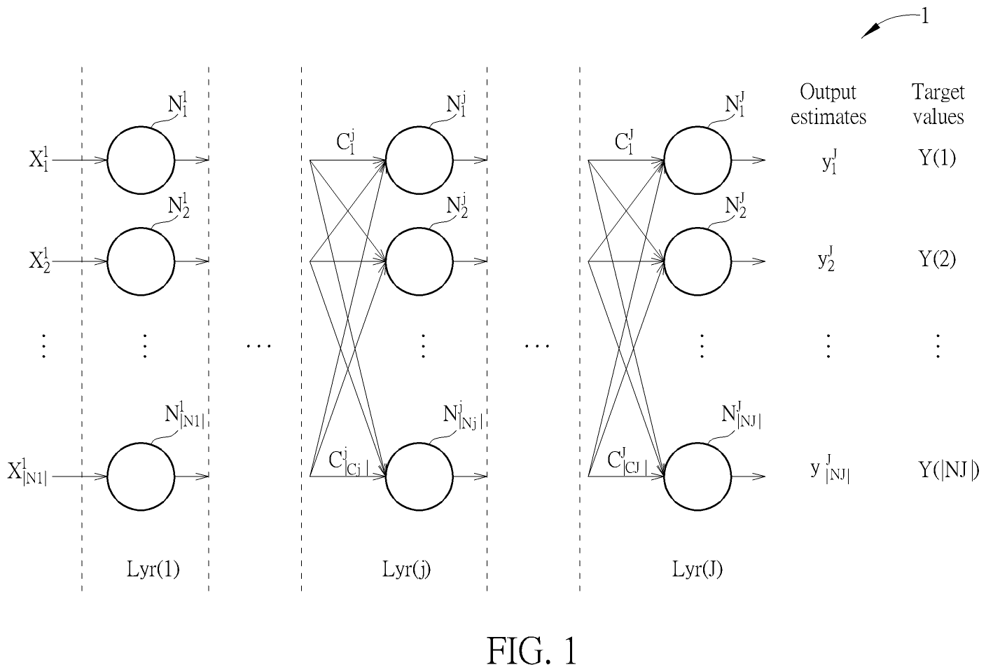

FIG. 1 is a computational graph of an artificial neural network 1 according to an embodiment of the invention. The artificial neural network 1 may generate output estimates y₁^{J} to y_{|NJ|}^{J} in response to input data x₁¹ to x_{|N1|}¹. The input data x₁¹ to x_{|N1|}¹ may be current levels, voltage levels, real signals, complex signals, analog signals or digital signals. For example, the input data x₁¹ to x_{|N1|}¹ may be grayscale values of pixels of an image, and may be obtained from an input device such as a mobile phone, a tablet computer or a digital camera. The output estimates y₁^{J} to y_{|NJ|}^{J} may represent respective probabilities of classification results of the artificial neural network 1. For example, the output estimates y₁^{J} to y_{|NJ|}^{J} may be probabilities of a variety of objects being identified from the image. A set of input data x₁¹ to x_{|N1|}¹ may be referred to as an input dataset. The artificial neural network 1 may be trained using a plurality of input datasets and respective target value sets. In some embodiments, the input datasets may be split into a plurality of mini-batches for training. For example, 32,000 instances of the input datasets may be divided into 1,000 mini-batches, with each mini-batch having a size of 32 input datasets.

The artificial neural network 1 may include layers Lyr(1) to Lyr(J), J being a positive integer exceeding 1. The layer Lyr(1) may be referred to as an input layer, the layer Lyr(J) may be referred to as an output layer, and layers Lyr(2) to Lyr(J−1) may be referred to as hidden layers. Each layer Lyr(j) may include a plurality of processing nodes coupled to a plurality of processing nodes in a preceding layer Lyr(j−1) via connections C₁^{J} to C_{|Cj|}^{j}, j being a layer index varying between 2 and J, and |Cj| is the total number of connections between the layer Lyr(j) and the preceding layer Lyr(j−1). The input layer Lyr(1) may contain processing nodes N₁¹ to N_{|N1|}¹, where the superscript represents a layer index, the subscript represents a node index, and |N1| is the total number of the processing nodes in the input layer Lyr(1). The processing nodes N₁¹ to N_{|N1|}¹ may receive input data x₁¹ to x_{|N1|}¹, respectively. Each hidden layer Lyr(j) in the hidden layers Lyr(2) to Lyr(J−1) may contain processing nodes N₁^{j} to N_{|Nj|}^{j}, where |Nj| is the total number of processing nodes in the hidden layer Lyr(j). The output layer Lyr(J) may contain processing nodes N₁^{J} to N_{|NJ|}^{J}, where |NJ| is the total number of the processing nodes in the output layer Lyr(J). The processing nodes N₁^{J} to N_{|NJ|}^{J} may generate output estimates y₁^{J} to y_{|NJ|}^{J}, respectively.

Each processing node in the layer Lyr(j) may be coupled to one or more processing nodes in the preceding layer Lyr(j−1) via connections therebetween. Each connection may be associated with a weight, the processing node may compute a weighted sum of one or more pieces of input data from the processing nodes in the preceding layer Lyr(j−1). A connection associated with a weight larger in magnitude is more influential in generating the weighted sum than a connection associated with a weight smaller in magnitude. When the value of a weight is 0, the connection associated with the weight may be regarded as being eliminated from the artificial neural network 1, achieving network connectivity sparsity, and reducing computational complexity, power consumption and operational costs. The artificial neural network 1 may be trained to include an optimized sparse network structure to deliver the output estimates y₁^{J} to y_{|NJ|}^{J} closely matching respective target values Y(1) to Y(|NJ|) using a reduced or minimal number of the connections C₁² to C_{|CJ|}^{J}.

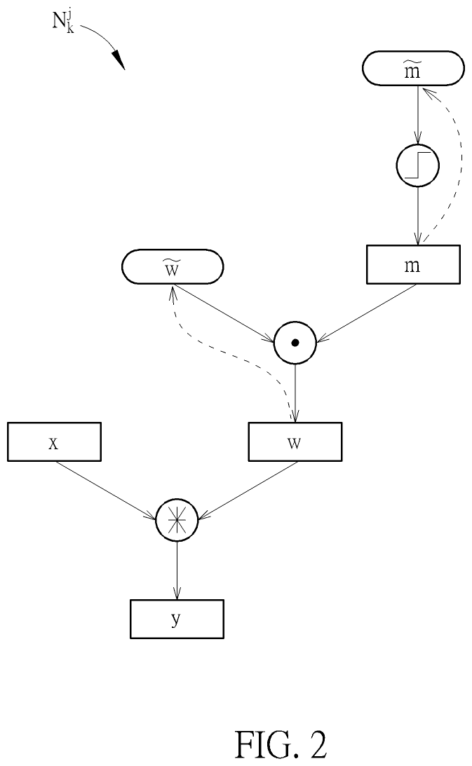

FIG. 2 is a schematic diagram of a processing node Nₖ^{j} in the layers Lyr(2) to Lyr(J) of the artificial neural network 1, j being a layer index ranging between 2 and J, and k being a node index ranging between 1 and |Nj|. The processing node Nₖ^{j} may be coupled to a preceding processing node via a connection. While only one connection is shown in FIG. 2, it should be appreciated that two or more connections may be connected to the processing node Nₖ^{j}. The processing node Nₖ^{j} may receive input data x from the preceding processing node, and convolve the input data x with a weight w to compute an output estimate y, as expressed by Equation (1):

y=w*x Equation (1)

The input data x may be (1×1) in size. The weight w may be referred to as a kernel, and may be (1×1) in size. “*” may represent a convolution operation. The output estimate y may be passed to a subsequent processing node as input data thereof to compute a subsequent output estimate. The weight w may be re-parameterized into a weight variable \tilde{w} and a connectivity mask m, as expressed by Equation (2):

w=\tilde{w}⊙m Equation (2)

The connectivity mask m may be a binary number representing connectivity of the connection, with 1 representing a connection and 0 representing no connection. The weight variable \tilde{w} may represent a strength of the connection. “⊙” may represent an element-wise multiplication. The connectivity mask m may be derived by performing a unit step operation H(•) on a connectivity variable \tilde{m}, as expressed by Equation (3).

$$m = H ( \overline{\tilde{m}} ) = \{ \begin{matrix}0 , \tilde{m} \leq 0 \\ 1 , \tilde{m} > 0\end{matrix} \qquad Equation ( 3 )$$

The processing node Nₖ^{j} may binarize the connectivity variable according to the unit step operation H(•) to generate the connectivity mask m. By re-parameterizing the weight w, the connectivity and the strength of the connection may be respectively trained by adjusting the connectivity variable \tilde{m} and the weight variable \tilde{w}. If the connectivity variable \tilde{m} is less than or equal to 0, the weight variable \tilde{w} may be zero-masked to generate a zero-weight w, and if the connectivity variable \tilde{m} exceeds 0, the weight variable \tilde{w} may be assigned as the weight w.

In the artificial neural network 1, the connections C₁² to C_{|CJ|}^{J} may be associated with connectivity variables \tilde{m}₁² to \tilde{m}_{|CJ|}^{J} and weight variables \tilde{w}₁² to \tilde{w}_{|CJ|}^{J}, respectively. The connectivity variables \tilde{m}₁² to \tilde{m}_{|CJ|}^{J} and weight variables \tilde{w}₁² to \tilde{w}_{|CJ|}^{J} may be trained according to an objective function to reduce a total number of the connections C₁² to C_{|CJ|}^{J} while reducing a performance loss of the artificial neural network 1. The total number of connections C₁² to C_{|CJ|}^{J} may be computed by summing all the connectivity masks m₁² to m_{|CJ|}^{J}. The performance loss may represent how different the output estimates y₁^{J} to y_{|NJ|}^{J} are from the respective target values Y(1) to Y(|NJ|), and may be computed in form of a cross entropy or a squared error. The objective function L may be expressed as Equation (4):

L=CE+λ1Σⱼ₌₂^{J}Σᵢ₌₁^{|Cj|}mᵢ^{j}+λ2Σⱼ₌₂^{J}Σᵢ₌₁^{|Cj|}(\tilde{w}ᵢ^{j})² Equation (4)

where CE is a cross entropy;

λ1 is a connectivity decay coefficient;

λ2 is a weight decay coefficient;

j is a layer index;

i is a mask index or a weight index;

mᵢ^{j} is the ith connectivity mask of a jth layer;

|Cj| is the total number of the connections of the jth layer; and

\tilde{w}ᵢ^{j} is the ith weight variable of the jth layer.

The objective function L may include the cross entropy CE between the output estimates y₁^{J} to y_{|NJ|}^{J} and the respective target values Y(1) to Y(|NJ|), an L0 regularization term of the total number of connections C₁² to C_{|CJ|}^{J}, and an L2 regularization term of the weight variables \tilde{w}₁² to \tilde{w}_{|CJ|}^{J} associated with the connections C₁² to C_{|CJ|}^{J}. In some embodiments, a sum of squared errors between the output estimates y₁^{J} to y_{|NJ|}^{J} and the respective target values Y(1) to Y(|NJ|) may replace the cross entropy CE in the loss function L. The L0 regularization term may be a product of the connectivity decay coefficient λ1 and the sum of the connectivity masks m₁² to m_{|CJ|}^{J}. The L2 regularization term may be a product of the weight decay coefficient λ2 and the sum of weight variables \tilde{w}₁² to \tilde{w}_{|CJ|}^{J}. In some embodiments, the L2 regularization term may be omitted from the loss function L. The artificial neural network 1 is trained to minimize the output result of the objective function L. Therefore, the L0 regularization term may penalize a large number of connections, and the L2 regularization term may penalize large weight variables \tilde{w}₁² to \tilde{w}_{|CJ|}^{J}. The larger the connectivity decay coefficient λ1 is, the sparser the neural network 1 will be. The connectivity decay coefficient λ1 may be set to be a large constant to drive the connectivity masks m₁² to m_{|NJ|}^{J} towards 0, pushing the connectivity variables \tilde{m}₁² to \tilde{m}_{|CJ|}^{J} towards the negative direction, and leading to a sparse connectivity structure of the artificial neural network 1. Only when a connection Cᵢ^{j} is important in reducing the cross entropy CE, the connectivity mask mᵢ^{j} associated with the connection Cᵢ^{j} may be left being 1. In this manner, a balanced point between reducing the cross entropy CE and reducing the total number of connections may be achieved to result in the sparse connectivity structure while producing the output estimates yᵢ^{J} to y_{|NJ|}^{J} substantially matching the target values Y(1) to Y(|NJ|). Similarly, the weight decay coefficient λ2 may be set to be a large constant to shrink the values of the weight variables \tilde{w}₁² to \tilde{w}_{|CJ|}^{J}, while the cross entropy CE ensures important weight variables remain in the artificial neural network 1, leading to a simple and accurate model of the artificial neural network 1.

During training of the connectivity variables \tilde{m}₁² to \tilde{m}_{|CJ|}^{J}, the input data x₁¹ to x_{|N1|}¹ may be fed into the input layer Lyr(1) and forward-propagated from the layers Lyr(1) to Lyr(J) to generate the output estimates y₁^{J} to y_{|NJ|}¹, errors between the output estimates y₁^{J} to y_{|NJ|}^{J} and the respective target values Y(1) to Y(|NJ|) may be computed and back-propagated from the layers Lyr(J) to Lyr(2) to compute connectivity variable gradients of an objective function L with respect to the connectivity variables \tilde{m}₁² to \tilde{m}_{|CJ|}^{J}, and then the connectivity variables \tilde{m}₁² to \tilde{m}_{|CJ|}^{J} may be adjusted according to the connectivity variable gradients with respect to the connectivity variables \tilde{m}₁² to \tilde{m}_{|CJ|}^{J}, so as to reduce a total number of the connections C₁² to C_{|CJ|}^{J} while reducing a performance loss of the artificial neural network 1. Specifically, the connectivity variable \tilde{m} may be adjusted until the corresponding connectivity variable gradient

$$\frac{\partial L}{\partial \tilde{m}}$$

reaches 0 in order to find a local minimum of the cross entropy CE. Nevertheless, according to the derivative chain rule, the computation of the connectivity variable gradient

$$\frac{\partial L}{\partial \tilde{m}}$$

involves differentiation of the unit step function in Equation (3), and the differentiation of the unit step function would result in 0 almost for all values of connectivity variable \tilde{m}, setting the connectivity variable gradient

$$\frac{\partial L}{\partial \tilde{m}}$$

to be 0, terminating the training process, and leading to no update of the connectivity variable \tilde{m}. In order to keep the connectivity variable \tilde{m} trainable during the training process, during backpropagation, the unit step function is skipped and the connectivity variable gradient

$$\frac{\partial L}{\partial \tilde{m}}$$

may be redefined as a connectivity mask gradient

$$\frac{\partial L}{\partial m}$$

of the objective function L with respect to the connectivity mask m, and may be expressed by Equation (5):

$$\frac{\partial L}{\partial \tilde{m}} : = \frac{\partial L}{\partial m} = \frac{\partial L}{\partial w} ⊙ \tilde{w} \qquad Equation ( 5 )$$

Referring to FIG. 2, the dotted line between the connectivity mask m and the connectivity variable \tilde{m} indicates that the unit step function is skipped during backpropagation. The connectivity variable \tilde{m} may be updated according to the connectivity mask gradient

$$\frac{\partial L}{\partial m} .$$

In some embodiments, the connectivity mask gradient

$$\frac{\partial L}{\partial m}$$

may be computed as an element-wise multiplication of a corresponding weight gradient

$$\frac{\partial L}{\partial w}$$

and the corresponding weight variable \tilde{w}, as indicated in Equation 5. In this fashion, when it is determined that the connection is negligible in reducing the cross entropy CE, the connectivity variable \tilde{m} may be updated from a positive number to a negative number, and the connectivity mask m may be updated from 1 to 0. When it is determined that the connection is essential in reducing the cross entropy CE, connectivity variable \tilde{m} may be updated from a negative number to a positive number, and the connectivity mask m may be updated from 0 to 1. In some embodiments, each mini-batch of input datasets may be input into the artificial neural network to generate plural sets of output estimates y₁^{J} to y_{|NJ|}^{J}, a mean error of the plural sets of output estimates y₁^{J} to y_{|NJ|}^{J} may be computed, and the connectivity variables \tilde{m}₁² to \tilde{m}_{|CJ|}^{J} may be trained according to backpropagation of the mean error. In some embodiments, the connectivity variable gradient

$$\frac{\partial L}{\partial \tilde{m}}$$

or the connectivity mask gradient

$$\frac{\partial L}{\partial m}$$

may be normalized to a standard deviation of 1 for each mini-batch of input datasets, in order to avoid different scales of the gradient

$$\frac{\partial L}{\partial w}$$

and the weight variable \tilde{w}.

Similarly, during training of the weight variables \tilde{w}₁² to \tilde{w}_{|CJ|}^{J}, weight variable gradients of the objective function L with respect to the weight variables \tilde{w}₁² to \tilde{w}_{|CJ|}^{J} may be computed by backpropagation of the errors, and then the weight variables \tilde{w}₁² to \tilde{w}_{|CJ|}^{J} may be adjusted according to the weight variables gradients, so as to reduce the weight variables \tilde{w}₁² to \tilde{w}_{|CJ|}^{J} while reducing the performance loss of the artificial neural network 1. the weight variable \tilde{w} may be adjusted until the corresponding weight variable gradient

$$\frac{\partial L}{\partial \tilde{w}}$$

reaches 0 in order to find a local minimum of the cross entropy CE. According to Equation (2) and the derivative chain rule, the weight variable gradient

$$\frac{\partial L}{\partial \tilde{w}}$$

may be expressed by Equation (6):

$$\frac{\partial L}{\partial \tilde{w}} = \frac{\partial L}{\partial w} ⊙ m \qquad Equation ( 6 )$$

According to Equation (5), the weight variable gradient

$$\frac{\partial L}{\partial \tilde{w}}$$

is 0 when the connectivity mask m is 0, leading to no update of the weight variable \tilde{w} and termination of the training process. In order to keep the weight variable \tilde{w} trainable, during backpropagation, the weight variable gradient

$$\frac{\partial L}{\partial \tilde{w}}$$

may be redefined as a weight gradient

$$\frac{\partial L}{\partial w}$$

of the objective function L with respect to the weight w, and may be expressed by Equation (7):

$$\frac{\partial L}{\partial \tilde{w}} := \frac{\partial L}{\partial w} \qquad Equation ( 7 )$$

By redefining the weight variable gradient

$$\frac{\partial L}{\partial \tilde{w}}$$

to be the weight gradient

$$\frac{\partial L}{\partial w} ,$$

the weight variable \tilde{w} may remain trainable even when the connectivity mask m is 0. Referring to FIG. 2, the dotted line between the weight wand the weight variable \tilde{w} indicates that the element-wise multiplication is skipped during backpropagation. The weight gradient

$$\frac{\partial L}{\partial w}$$

may be obtained by backpropagation. The weight variable \tilde{w} may be updated according to the weight gradient

$$\frac{\partial L}{\partial w}$$

regardless of the connectivity mask m being 1 or 0. In this fashion, the weight variables \tilde{w}₁² to \tilde{w}_{|CJ|}^{J} may be trained even if some of the weight variables \tilde{w}₁² to \tilde{w}_{|CJ|}^{J} are zero-masked temporarily.

The artificial neural network 1 separates the weights w into the connectivity variables \tilde{m} and the weight variables \tilde{w}, trains the connectivity variables \tilde{m} to form sparse connectivity structure, and trains the weight variables \tilde{w} to form a simple model for the artificial neural network 1. Further, in order to train the connectivity variables \tilde{m} and the weight variables \tilde{w}, the connectivity variable gradient

$$\frac{\partial L}{\partial \tilde{m}}$$

is redefined as the connectivity mask gradient

$$\frac{\partial L}{\partial \tilde{w}}$$

and the weight variable gradient

$$\frac{\partial L}{\partial m} ,$$

is redefined as the weight gradient

$$\frac{\partial L}{\partial w} .$$

The resultant sparse connectivity structure of the artificial neural network 1 can significantly reduce computational complexity, memory requirements and power consumption.

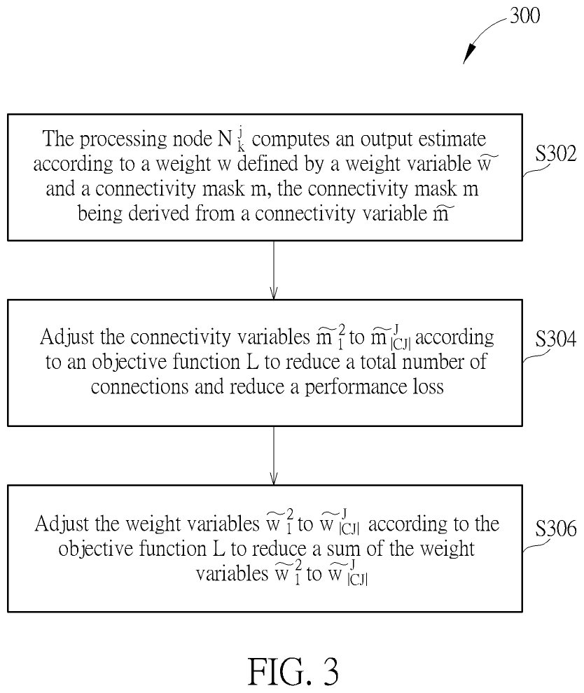

FIG. 3 is a flowchart of a training method 300 for use to train the artificial neural network 1. The method 300 comprises Steps S302 to S306, training the artificial neural network 1 to form a sparse connectivity structure. Step S302 is used by a processing node Nₖ^{j} in the artificial neural network 1 to generate an output estimate, Steps S304 and S306 are used to train the connectivity variables \tilde{m}₁² to \tilde{m}_{|CJ|}^{J} and the weight variables \tilde{w}₁² to \tilde{w}_{|CJ|}^{J}, respectively. Any reasonable step change or adjustment is within the scope of the disclosure. Steps S302 to S306 are explained as follows:

Step S302: The processing node Nₖ^{j} computes an output estimate according to a weight w defined by a weight variable \tilde{w} and a connectivity mask m, the connectivity mask m being derived from a connectivity variable \tilde{m};

Step S304: Adjust the connectivity variables \tilde{m}₁² to \tilde{m}_{|CJ|}^{J} according to an objective function L to reduce a total number of connections and reduce a performance loss;

Step S306: Adjust the weight variables \tilde{w}₁² to \tilde{w}_{|CJ|}^{J} according to the objective function L to reduce a sum of the weight variables \tilde{w}₁² to \tilde{w}_{|CJ|}^{J}.

Explanations for Steps S302 to S306 are provided in the preceding paragraph and will not be repeated here. The training method 300 trains the connectivity variables \tilde{m}₁² to \tilde{m}_{|CJ|}^{J} and the weight variables \tilde{w}₁² to \tilde{w}_{|CJ|}^{J} separately to generate an artificial neural network 1 that is sparse in connection, simple in structure, and accurate in output prediction.

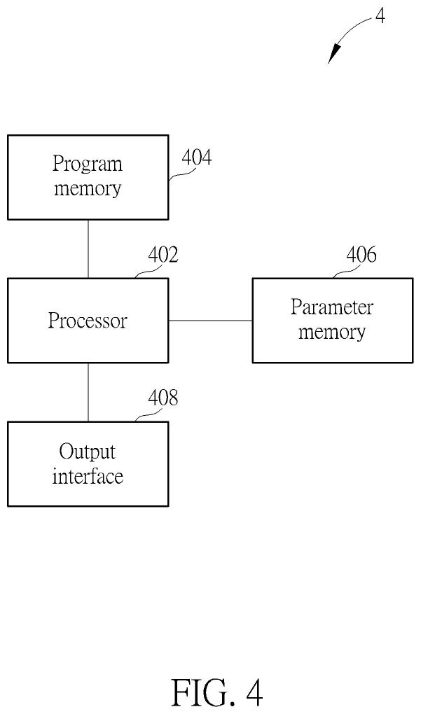

FIG. 4 illustrates an exemplary computing network 4 for constructing the artificial neural network 1. The computing network 4 includes a processor 402, a program memory 404, a parameter memory 406 and an output interface 408. The program memory 404 and the parameter memory 406 may be non-volatile memories. The processor 402 may be coupled to the program memory 404 and the parameter memory 406 to control operations thereof. The weights w₁² to w_{|CJ|}^{J}, weight variables \tilde{w}₁² to \tilde{w}_{|CJ|}^{J}, connectivity masks m₁² to m_{|CJ|}^{J}, connectivity variables \tilde{m}₁² to \tilde{m}_{|CJ|}^{J} and associated gradients may be stored in the parameter memory 406, while instructions relating to training the connectivity variables \tilde{m}₁² to \tilde{m}_{|CJ|}^{J} and the weight variables \tilde{w}₁² to \tilde{w}_{|CJ|}^{J} may be loaded from the program memory 404 to the processor 402 during the training process. The instructions may include code for the processing node Nₖ^{j} to compute an output estimate according to a weight w defined by a weight variable \tilde{w} and a connectivity mask m, code for adjusting the connectivity variables \tilde{m}₁² to \tilde{m}_{|CJ|}^{J} according to an objective function L, and code for adjusting the weight variables \tilde{w}₁² to \tilde{w}_{|CJ|}^{J} according to an objective function L. The adjusted connectivity variables \tilde{m}₁² to \tilde{m}_{|CJ|}^{J} and the adjusted weight variables \tilde{w}₁² to \tilde{w}_{|CJ|}^{J} may be updated in the parameter memory 406 to replace old data. The output interface 408 may display the output estimates y₁^{J} to y_{|NJ|}^{J} in response to the input dataset.

The artificial neural network 1 and the training method 300 are utilized to train the connectivity variables \tilde{m}₁² to \tilde{m}_{|CJ|}^{J} and the weight variables \tilde{w}₁² to \tilde{w}_{|CJ|}^{J}, producing sparse network connectivity while delivering accurate outputs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of training a computing network comprising a plurality of processing nodes, the method comprising:
a processing node in the plurality of processing nodes computing an output estimate according to a weight defined by a weight variable and a connectivity mask, the connectivity mask representing a connection between the processing node and a preceding processing node in the plurality of processing nodes and being derived from a connectivity variable; and
adjusting connectivity variables according to an objective function to reduce a total number of connections between the plurality of processing nodes and reduce a performance loss indicative of how different the output estimate is from a target value.

2. The method of claim 1, wherein adjusting the connectivity variables according to the objective function comprises:
computing a connectivity mask gradient of the objective function with respect to the connectivity mask; and
updating the connectivity variable according to the connectivity mask gradient.

3. The method of claim 1, further comprising:
the processing node binarizing the connectivity variable according to a unit step function to generate the connectivity mask.

4. The method of claim 1, wherein the objective function comprises a first term corresponding to the performance loss and a second term corresponding to regularization of connectivity masks associated with the connections between the plurality of processing nodes.

5. The method of claim 4, wherein the second term comprises a product of a connectivity decay coefficient and a sum of the connectivity masks associated with the connections between the plurality of processing nodes.

6. The method of claim 4, wherein the objective function further comprises a third term corresponding to regularization of weight variables associated with the connections between the plurality of processing nodes.

7. The method of claim 6, wherein the third term comprises a product of a weight decay coefficient and a total number of the weight variables associated with the connections between the plurality of processing nodes.

8. The method of claim 1, wherein the performance loss may be a cross entropy.

9. The method of claim 1, further comprising:
adjusting weight variables according to the objective function to reduce a sum of weight variables associated with the connections between the plurality of processing nodes.

10. The method of claim 9, wherein adjusting weight variables according to the objective function comprises:
computing a weight gradient of the objective function with respect to the weight; and
updating the weight variable according to the weight gradient.
